(19) United States
(12) Patent Application Publication
(10) Pub. No.: US 2015/0173326 A1
(43) Pub. Date: Jun. 25, 2015

(54) Swivel Arm Assembly For Animal Tether

(71) Applicant: Johnny M. Pittman, Hickory, NC (US)

(72) Inventor: Johnny M. Pittman, Hickory, NC (US)

(21) Appl. No.: 14/569,805

(22) Filed: Dec. 15, 2014

Related U.S. Application Data
(60) Provisional application No. 61/980,301, filed on Apr. 16, 2014.
(60) Provisional application No. 61/920,720, filed on Dec. 24, 2013.

(51) Int. Cl. A01K 1/04; A01K 27/00

(52) U.S. Cl. CPC A01K 1/04; A01K 27/003; A01K 27/001; A01K 27/002

(57) ABSTRACT

A tether system for restraining and/or training a domestic animal includes a vertical member having an uppermost end adapted to receive a swivel arm assembly. The swivel arm assembly includes a rigid extension arm, a rotatable swivel attached to one end of the extension arm at the vertical member, and a clevis movably attached to the other end of the extension arm. The tether system further includes a suitable length of a tether having a first end attached to the clevis and a second end configured for attachment to a collar, harness, yoke or the like, provided on the animal. The vertical member is suitably secured within the ground in a generally vertical orientation and the swivel of the swivel arm assembly is configured to rotate freely about a vertical axis defined by the vertical member such that the extension arm likewise rotates freely about the vertical axis.

### CROSS REFERENCE To RELATED APPLICATIONS

This United States non-provisional utility patent application claims the benefit of priority to the filing date of U.S. Provisional Application No. 61/920,720 filed on Dec. 24, 2013, and further to United States Provisional Application No. 61/980,301 filed on April 16, 2014, the entire disclosures of which are incorporated herein by reference.

### FIELD OF THE INVENTION

The present invention relates generally to an animal tether for restraining and/or training a domestic animal, for example a horse or a dog. More specifically, the invention is a swivel arm assembly configured for use with an animal tether. In exemplary embodiments, the invention is an animal tether including a swivel arm assembly that confines a domestic animal within a designated area, and thereby trains the domestic animal to stand relatively still.

### BACKGROUND OF THE INVENTION

Mankind has long kept domestic animals for work and as pets. It is believed that Eurasian man domesticated the first animal, namely dogs, as early as about 30,000 BC. Eurasians were also the first to domesticate wild horses as early as about 4000 BC. Ever since, man has sought effective ways to restrain and train domestic animals. The most commonplace form of restraint has always been to tie the animal to a stationary object, for example a tree or grounded structure, by means of a length of rope, cable or chain, commonly referred to as a “tether.” A tether having suitable strength is an effective means for confining the animal to a designated area until the animal is released from the tether. If the tether is not sufficiently strong, it may break and the animal no longer restrained from departing the designated area. Even if the tether is sufficiently strong, the animal may repeatedly pull against the taut tether and eventually sever it or decouple it from the stationary object, thereby freeing itself from the restraint.

Another problem is commonly encountered when attempting to restrain a domestic animal, and more specifically, a horse. A horse naturally tends to move backwards when tethered to a tree, post, hitching rail or the like. A sudden backwards movement of the horse may result in injury to the person attempting to restrain the horse or to a person in the vicinity of the rear of the horse. Furthermore, the horse may injury itself by backing suddenly against a tether secured to a stationary object. Thus, it is desirable to train a horse to stand relatively still when being tethered and to remain relatively still while tethered.

Accordingly, what is needed is an apparatus for securely tethering an animal to a stationary object that overcomes the problems and deficiencies with the known tethers. More specifically, there exists a need for a tether system that is not susceptible to being severed or decoupled from the stationary object. In addition, there exists a need for a tether system that is useful for training an animal to stand relatively still when being tethered and to remain relatively still while tethered.

### SUMMARY OF THE INVENTION

The invention relates to a tether system for restraining and/or training a domestic animal, for example a dog or a horse. More specifically, the invention is a swivel arm assembly configured for use with an animal tether. The swivel arm assembly confines movement of the animal within a designated area and at the same time trains the animal not to pull against the taut tether. In exemplary embodiments, the tether system includes a post, pole, mast or the like that is secured in a vertical orientation to a generally horizontal support surface, such as the ground or the floor of a barn or other building structure. The uppermost end of the vertical member is adapted to receive a swivel arm assembly configured for use with the tether system. The swivel arm assembly includes a rigid extension arm, a rotatable swivel attached to one end of the extension arm at the vertical member, and a clevis movably attached to the other end of the extension arm at a predetermined distance from the vertical member. The tether system further includes a suitable length of rope, cable, chain or the like (collectively referred to herein as a “tether”) attached to the clevis provided on the swivel arm assembly at one end and having a carabineer clip or the like at the other end for attachment to a collar, harness, yoke or the like, provided on the animal.

In an exemplary embodiment of the invention, the vertical member is suitably secured within the ground in a generally vertical orientation and the swivel arm assembly is attached to the uppermost end of the vertical member. In one embodiment, a base of the swivel arm assembly is secured to the uppermost end of the vertical member by a plurality of lag bolts that extend through the base and into the vertical member. In another embodiment, the base of the swivel arm assembly is secured to the uppermost end of a vertical member made of a metal by means of welding, brazing or the like. The swivel portion of the swivel arm assembly is configured to rotate freely about a lengthwise (i.e. vertical) axis of the vertical member. The swivel portion is attached to one end of the extension arm portion such that the extension arm likewise rotates freely about a vertical axis relative to the ground. If desired, the one end of the extension arm may be attached to the swivel by means of a pivot pin such that the extension arm can be rotated upwards about a generally horizontal axis relative to the ground. However, rotation of the extension arm about the horizontal axis in the downward direction is preferably restricted by a mechanical stop, such as an outer surface of a housing of the swivel.

The clevis of the swivel arm assembly is movably attached to the other end of the extension arm. In a preferred embodiment, the clevis is attached to the other end of the extension arm by means of a smooth pivot pin. In this manner, the clevis is free to rotate relative to the extension arm about a generally horizontal axis relative to the ground. The clevis is configured to receive one end of a suitable length of the tether (e.g., rope, cable or chain) based on the height of the clevis above the ground and the size of the animal to be retrained and/or trained by the tether system. If desired, the extension arm may be formed with an angled length portion and a straight length portion so that the clevis is positioned to hang under the influence of gravity in a generally vertical orientation when attached to the end of the extension arm. An animal is secured to the other end of the tether, for example by a collar, harness, yoke or the like. In this manner, the swivel arm assembly rotates about the vertical member of the tether system when the animal pulls against the taut tether. As a result, the animal is confined to move within a designated area defined by a circle having a radius equal to the horizontal distance of the clevis and the tether from the vertical member.

In one embodiment, the swivel portion is a commercially available caster of the type commonly utilized for the wheels of heavy duty furnishings, moving carts, hand trucks, work dollies and the like. The caster includes an inner housing fixed to the base of the swivel arm assembly and an outer housing that is rotatably mounted on the inner housing. The inner housing and the outer housing together define an internal raceway for receiving a set of smooth bearings such that the outer housing is rotatable relative to the inner housing. In advantageous embodiments, the bearings are sealed within the inner housing and the outer housing, and the caster is weather proof and corrosion resistant. The caster may be provided with at least one vertically extending notch on the periphery of the outer housing that is configured, and in particular, is sized and shaped to receive a lower edge of the extension arm. If desired, the lower edge of the extension arm may be coated with a relatively elastic material, such as rubber, soft plastic or the like, to enhance the retention of the extension arm on the caster and/or to reduce noise that may be produced when the extension arm moves within the notch relative to the swivel portion of the swivel arm assembly.

### BRIEF DESCRIPTION OF THE DRAWINGS

FIG. 1 is an environmental perspective view illustrating a tether system including a swivel arm assembly constructed in accordance with the invention for retraining and/or training an animal.

FIG. 2 is a perspective view of the swivel arm assembly of the tether system illustrated in FIG. 1.

FIG. 3 is a side elevation view of the swivel arm assembly of FIG. 2.

FIG. 4 is a detailed perspective view illustrating a means for attaching the clevis to the extension arm of the swivel arm assembly shown in FIG. 2.

FIG. 5 is a side elevation view of another swivel arm assembly constructed in accordance with the invention.

FIG. 6 is a top perspective view of a portion of the swivel arm assembly of FIG. 5 showing the swivel portion in greater detail.

FIG. 7 is an exploded perspective view showing the components of the swivel portion of the swivel arm assembly of FIG. 5.

FIG. 8A is a perspective view showing the lower edge of the extension arm out of engagement with the swivel of the swivel arm assembly of FIG. 5.

FIG. 8B is a perspective view showing the lower edge of the extension arm in engagement with the swivel of the swivel arm assembly of FIG. 5.

### DETAILED DESCRIPTION OF EMBODIMENTS OF THE INVENTION

Exemplary embodiments of the invention are shown and described herein with reference to the accompanying drawing figures, in which like reference characters refer to the same or similar parts.

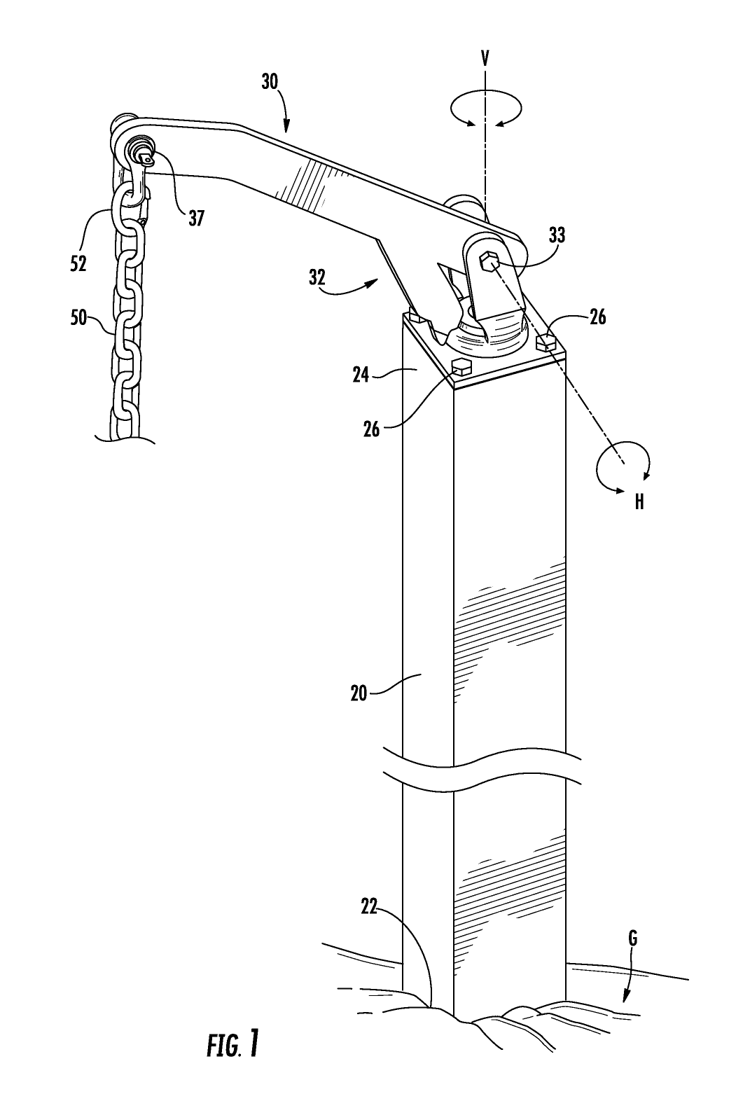

FIG. 1 is an environmental perspective view illustrating a tether system 10 for restraining and/or training a domestic animal, for example a dog or a horse. The tether system includes an elongate post, pole, mast or the like, collectively referred to herein as a “vertical member” 20, defining a lengthwise axis. A lowermost end 22 of the vertical member 20 is adapted to be secured within a generally horizontal support surface, such as the ground or the floor of a barn or other building structure. As shown in FIG. 1, the lowermost end 22 of the vertical member 20 is suitably secured within the ground G, preferably in a generally level horizontal area. An uppermost end 24 of the vertical member 20 is adapted to receive a swivel arm assembly 30 according to the invention configured for use with the tether system 10. The swivel arm assembly 30 may be attached to the uppermost end 24 of the vertical member 20 in any suitable manner. By way of example and not limitation, a base of the swivel arm assembly 30 is attached to the uppermost end 24 of the vertical member 20 by means of a plurality of lag bolts 26 shown in FIG. 1. In another embodiment, the base of the swivel arm assembly 30 may be attached to the uppermost end 24 of a vertical member 20 made of a metal by means of welding, brazing or the like.

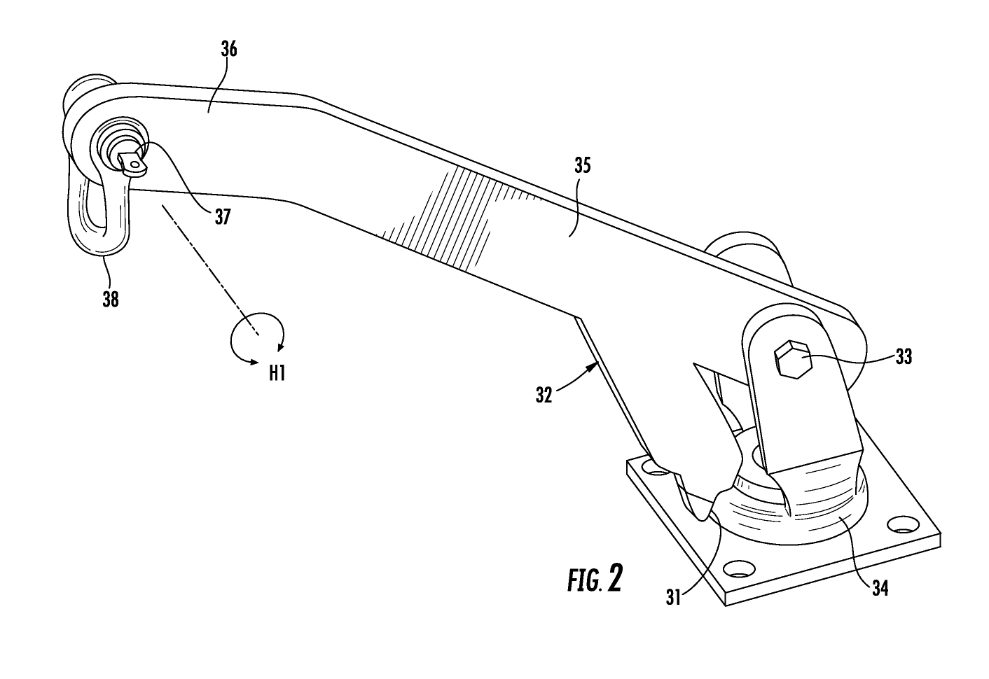

As best shown in FIG. 2 and FIG. 3, swivel arm assembly 30 comprises a rigid extension arm 32, a rotatable swivel 34 attached to one end of the extension arm at the uppermost end 24 of the vertical member 20, and a clevis 38 attached to the other end of the extension arm distal from the vertical member at a distance determined by the horizontal length of the extension arm. The swivel portion 34 of the swivel arm assembly 30 is adapted to rotate freely about a generally vertical axis V (FIG. 1) defined by the lengthwise axis of the vertical member 20. The one end of the extension arm 32 is attached to the swivel 34 by means of a pivot pin 33 such that the extension arm can be rotated in an upwards direction about a generally horizontal axis H (FIG. 1) relative to the ground G. If desired, rotation of the extension arm 32 about the horizontal axis H in a downwards direction may be restricted, or prevented, by a mechanical stop 31.

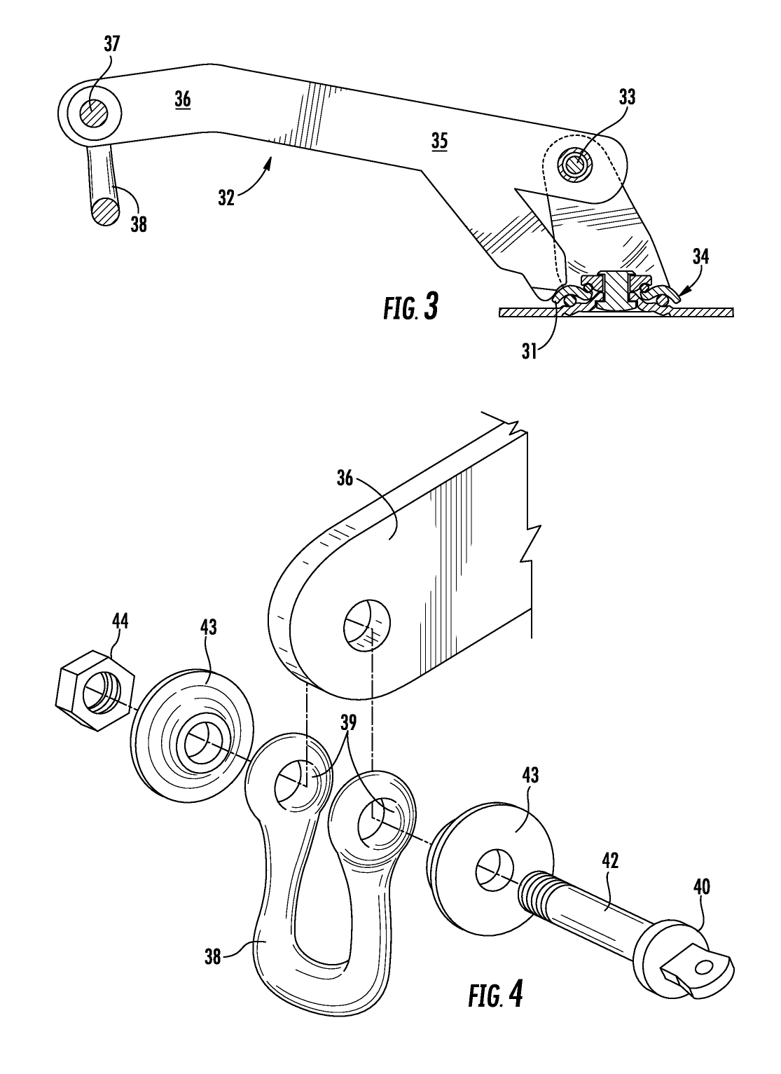

As best shown in FIG. 2 and FIG. 3, the extension arm 32 comprises an angled length portion 35 and a straight length portion 36 such that the other end of the extension arm distal from the vertical member 20 is generally horizontal relative to the ground G. The clevis 38 of the swivel arm assembly 30 is attached to the other end of the extension arm 32 by means of a pivot pin assembly 37. In this manner, the clevis 38 is movable relative to the extension arm 32 about a generally horizontal axis H1 (FIG. 2) relative to the ground G. Furthermore, the clevis 38 hangs in a generally vertical orientation adjacent an end of the extension arm 32. As shown in FIG. 4, the clevis 38 is generally U-shaped and is provided with a pair of openings 39 for receiving a bolt 40 having a smooth center portion 42. The bolt 40 is secured to the clevis 38 with a pair of slip washers 43 and an internally threaded nut 44 that engages external threads provided on one end of the bolt. Clevis 38 may be sized and shaped, to receive a link on an end of a length of a chain, as will be described herein below.

A predetermined length of a tether 50, shown herein in FIG. 1 as a length of chain having a plurality of interconnected links, is attached to the clevis 38 in a suitable manner. By way of example and not limitation, a link of the tether 50 chain may be disposed onto the clevis 38 before the clevis is attached to the extension arm 32 by the pivot pin assembly 37. Alternatively, the tether 50 may be attached to the clevis 38 by means of a carabineer clip 52. Regardless, the length of the tether 50 is determined by the height of the clevis 38 above the ground G and the height of the animal to be restrained and/or trained. The animal is secured to the other end of the tether 50 in a suitable manner, for example by a collar, harness, yoke or the like, that may receive a carabineer clip provided on the end of the tether. Accordingly, the swivel arm assembly 30 rotates about the vertical member 20 of the tether system 10 when the animal pulls against the taut tether 50. As a result, the animal is confined to move within a circle having a desired radius defined by the horizontal distance of the clevis 38 and the horizontal length of the tether 50 from the vertical member 20. Thus, the animal is effectively restrained from departing the desired area. At the same time, movement of the animal against the taut tether 50 does not cause injury to the animal. Furthermore, the animal is trained to stand relatively still because pulling against the taut tether 50 does not result in a resistive counterforce. Accordingly, the animal does not have the sensation of being tethered to a stationary object.

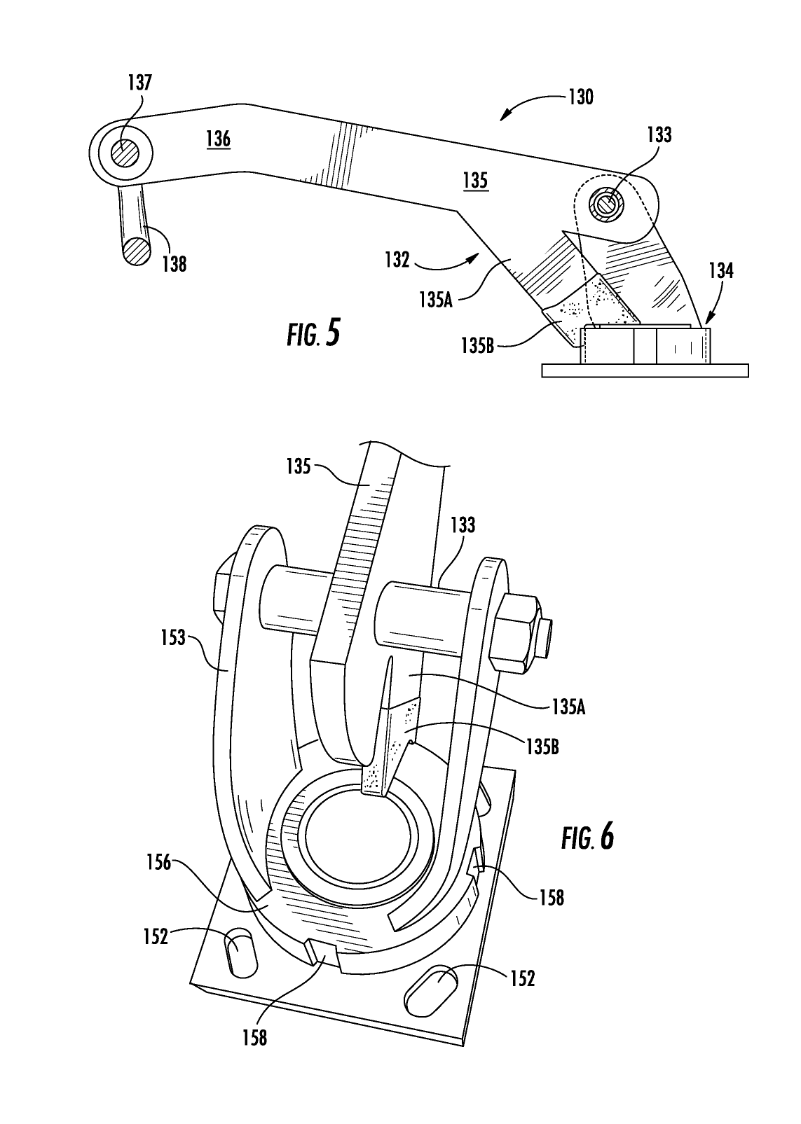

FIGS. 5-7, 8A and 8B show another swivel arm assembly 130 constructed in accordance with the invention. The swivel arm assembly 130 is configured for use and operation in the same manner as previously described with respect to the swivel arm assembly 30. However, swivel arm assembly 130 comprises a modified extension arm 132 and swivel 134. Extension arm 132 comprises an angled length portion 135 and a straight length portion 136, as previously described. However, the angled length portion 135 has a modified lower portion 135A configured to operably engage the swivel 134.

As shown, swivel 134 is a commercially available “Kingpinless” type caster rig commonly used for the wheels of heavy duty furnishings, moving carts, hand trucks, work dollies, and the like. An example of a Kingpinless caster (also commonly referred to as a “wheel float”) suitable for use with the invention is available from Plane Easy, LLC of Fresno Calif., USA.

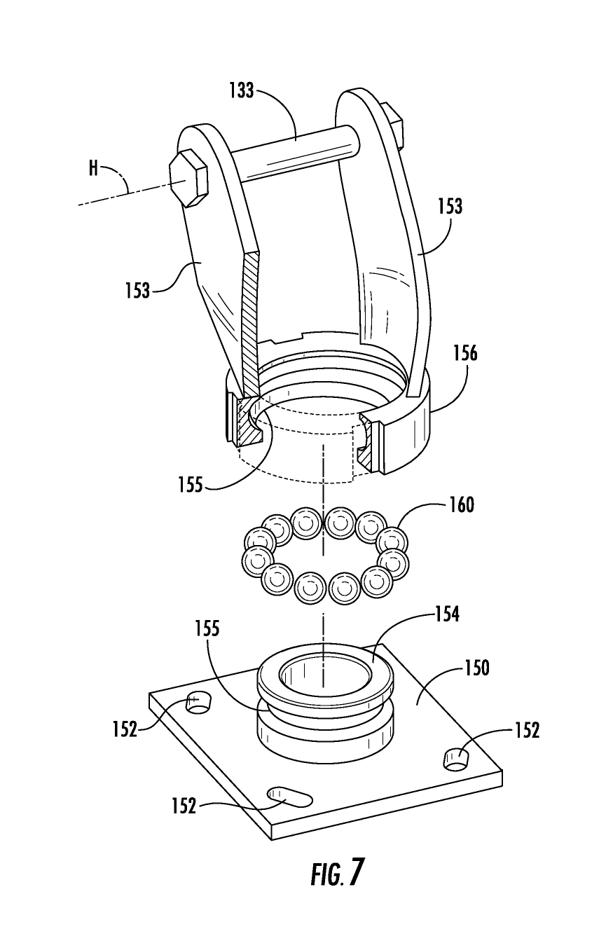

The swivel 134 comprises a base 150 that is configured to attach to the uppermost end 24 of the vertical member 20 in any of the manners previously described. For example, the base 150 may be provided with a plurality of through holes 152 for receiving lag bolts 26 to attach the swivel assembly 130 to a vertical member made of wood. Alternatively, the base 150 made be attached to a vertical member 20 made of metal by welding, brazing or the like. Regardless, swivel 134 further comprises an inner housing 154 (FIG. 7) and an outer housing 156. The outer housing 156 has at least one, and preferably, a plurality of notches 158 formed therein around its periphery. As shown, outer housing 156 has four (4) notches 158 formed therein at equally spaced circumferential locations around the periphery. As such, the notches 158 are spaced apart by about ninety degrees (90°). Swivel 134 further comprises a pair of spaced apart pivot arms 153 depending outwardly from the outer housing 156. The pivot arms 153 receive a pivot pin 133 with the angled length portion 135 of the extension arm 132 disposed medially between the pivot arms, such that the extension arm is rotatable relative to the swivel 134 about an axis H defined by the pivot pin (FIG. 6).

The inner housing 154 and the outer housing 156 together define an internal raceway 155 for receiving a plurality of smooth bearings 160. The inner housing 154 and the outer housing 156 are manufactured in such a manner that the internal raceway 155 and bearings 160 are essentially sealed from the ambient environment. Accordingly, the bearings 160 are weather proof. If desired, the swivel 134 may be provided with a lubricating port (not shown) that defines a passageway in fluid communication with the internal raceway 155 for delivering a lubricant to the bearings 160 in a manner known, or readily apparent, to those skilled in the art. Furthermore, the swivel 134 may be anodized or powder-coated in a known manner to provide corrosion resistance. Regardless, the outer housing 156, including pivot arms 153, pivot pin 133 and extension arm 132, is rotatable relative to the inner housing 154 about a vertical axis V.

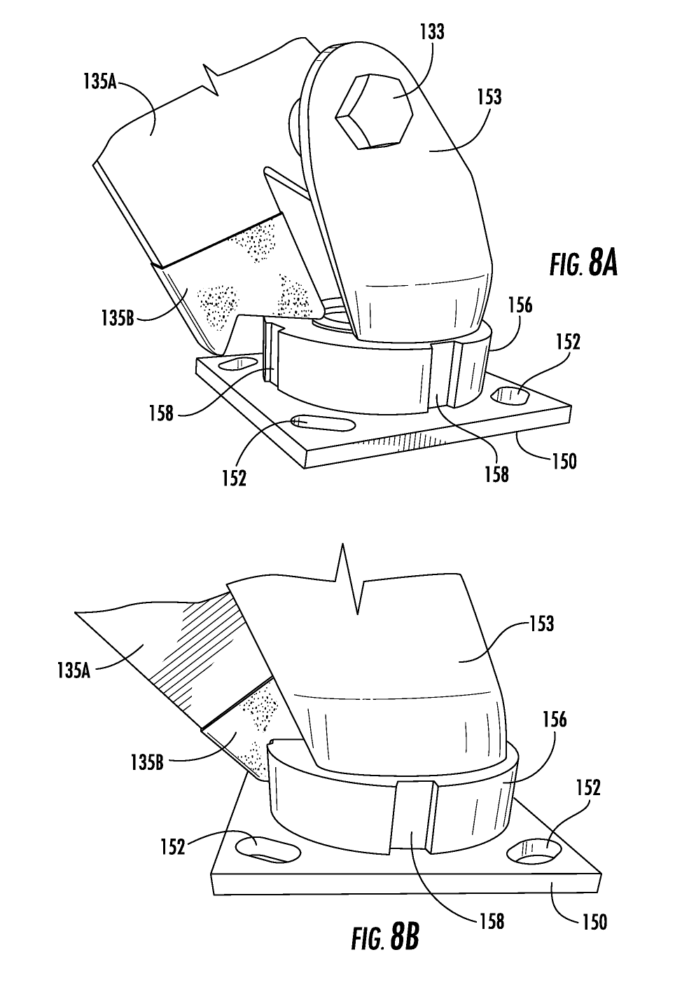

As shown in FIG. 8A, the extension arm 132, and in particular, the lower portion 135A of the angled length portion 135 of the extension arm is rotatable on the pivot pin 133 about the horizontal axis H (FIG. 7) in an upward direction off the outer housing 156 of the swivel 134. FIG. 8B shows the lower portion 135A of the extension arm 132 disposed within a notch 158 defined by the outer housing 156 of the swivel 134. As previously mentioned, the lower portion 135A of the extension arm 132 is configured to operably engage one of the notches 158 formed on the periphery of the outer housing 156 of the swivel 134. Specifically, the lower portion 135A is sized and shaped to be received within the notch 158 and to form a mechanical stop with the outer housing 156 to prevent downward movement of the extension arm 132 relative to the swivel 134 about the horizontal axis H. As shown, a suitable extent of the lower portion 135A may be covered or coated with a relatively elastic material, for example rubber or soft plastic, 135B to provide for more secure retention of the lower portion within the notch 158. The relatively elastic material 135B may additionally provide sound dampening by reducing the amount of noise produced when the lower portion 135A of the extension arm 132 makes contact with the notch 158 after being lifted off the outer housing 156 of the swivel 134.

The foregoing has described one or more exemplary embodiments of a tether system including a swivel arm assembly for restraining and/or training a domestic animal, for example a dog or a horse. More particularly, exemplary embodiments of a tether system, including novel and unobvious embodiments of a swivel arm assembly, for effectively restraining and training a domestic animal to remain relatively still when tethered to a stationary object, while reducing the potential for injury to the animal, have been disclosed.

That which is claimed is:

1. A tether system comprising:
an elongate vertical member secured in a generally vertical orientation;
a swivel arm assembly attached to the vertical member and configured for confining movement of an animal within a designated area, the swivel arm assembly comprising:
a substantially rigid extension arm having a first end proximate the vertical member and a second end distal from the vertical member;
a rotatable swivel operably coupled to the first end of the extension arm; and
a clevis movably attached to the second end of the extension arm at a predetermined distance distal from the vertical member; and
an elongate tether having a length with a first end attached to the clevis of the swivel arm assembly and a second end distal from the clevis.

2. The tether system according to claim 1, further comprising an attachment member at the second end of the tether configured for attaching an animal to the tether.

3. The tether system according to claim 2, wherein the attachment member is selected from the group consisting of a collar, a harness, and a yoke.

4. The tether system according to claim 1, wherein the rotatable swivel is configured to rotate freely about a vertical axis defined by a lengthwise axis of the vertical member.

5. The tether system according to claim 1, wherein the first end of the extension arm is pivotally connected to the swivel such that the extension arm is movable about a horizontal axis relative to a vertical axis defined by a lengthwise axis of the vertical member.

6. The tether system according to claim 5, wherein the extension arm is movable in an upwards direction relative to the horizontal axis and wherein a downward movement of the extension arm is prevented by a mechanical stop.

7. The tether system according to claim 1, wherein the extension arm of the extension arm assembly comprises an angled length portion and a straight length portion such that the straight length portion of the extension arm is oriented generally horizontal relative to the vertical member.

8. The tether system according to claim 1, wherein the clevis of the swivel arm assembly is attached at the second end of the extension arm by means of a pivot pin assembly such that the clevis is movable relative to the extension arm about a generally horizontal axis relative to a vertical axis defined by a lengthwise axis of the vertical member and hangs in a generally vertical orientation.

9. The tether system according to claim 8, wherein the clevis is generally U-shaped and is provided with a pair of openings for receiving a bolt that is secured to the clevis.

10. The tether system according to claim 1, wherein the swivel portion comprises a base configured to be attached to an uppermost end of the vertical member, an inner housing and an outer housing, the outer housing having at least one notch formed therein on a periphery of the outer housing, and wherein the swivel portion further comprises a pair of spaced apart pivot arms depending outwardly from the outer housing and configured to receive a pivot pin such that the extension arm is disposed medially between the pivot arms and is rotatable relative to the swivel portion about the pivot pin.

11. A swivel arm assembly configured for use with an animal tether system, the swivel arm assembly comprising:
a rigid extension arm having a first end and a second end;
a rotatable swivel attached at the first end of the extension arm; and
a clevis attached at the second end of the extension arm;
wherein the extension arm of the swivel arm assembly is adapted to rotate freely relative to the swivel about a generally vertical axis defined by a lengthwise axis of a vertical member of the animal tether system.

12. The swivel arm assembly according to claim 11, wherein the first end of the extension arm is attached to the swivel by means of a pivot pin such that the extension arm is rotatable in an upwards direction about a generally horizontal axis relative to the vertical axis defined by the vertical member of the animal tether system.

13. The swivel arm assembly according to claim 12, wherein rotation of the extension arm about the horizontal axis in a downwards direction relative to the upwards direction is prevented by a mechanical stop.

14. The swivel arm assembly according to claim 11, wherein the extension arm comprises an angled length portion adjacent the first end of the extension arm and a straight length portion adjacent the second end of the extension arm distal from the vertical member of the animal tether system, and wherein the straight length portion of the extension arm is generally horizontal relative to the vertical axis defined by the vertical member of the animal tether system.

15. The swivel arm assembly according to claim 11, wherein the clevis of the swivel arm assembly is attached to the second end of the extension arm by means of a pivot pin assembly such that the clevis hangs in a generally vertical orientation and is movable relative to the extension arm about a generally horizontal axis relative to the vertical axis defined by the vertical member of the animal tether system.

16. The swivel arm assembly according to claim 15, wherein the clevis is generally U-shaped and is provided with a pair of openings for receiving a bolt that is secured to the clevis with a pair of slip washers and an internally threaded nut that engages external threads provided on an end of the bolt.

17. The swivel arm assembly according to claim 11, wherein a first end of a predetermined length of a tether is attached to the clevis and a second end of the tether is configured to be attached to an animal.

18. The swivel arm assembly according to claim 11, wherein the extension arm comprises an angled length portion and a straight length portion, and wherein the angled length portion has a lower portion configured to operably engage the swivel.

19. The swivel arm assembly according to claim 18, wherein the swivel comprises a base that is configured to attach to the vertical member of the animal tether system, an inner housing and an outer housing, wherein the outer housing has at least one notch formed therein on a periphery of the outer housing and a pair of spaced apart pivot arms depending outwardly from the periphery of the outer housing, and wherein the pivot arms receive a pivot pin with the angled length portion of the extension arm disposed medially between the pivot arms such that the extension arm is rotatable relative to the swivel about a horizontal axis relative the vertical axis defined by the vertical member of the animal tether system.

20. The swivel arm assembly according to claim 19, wherein the lower portion of the angled portion of the extension arm is configured to operably engage with the at least one notch on the periphery of the outer housing of the swivel and thereby form a mechanical stop with the outer housing to prevent downward movement of the extension arm relative to the swivel about the horizontal axis.
